(19) United States
(12) Patent Application Publication
(10) Pub. No.: US 2013/0321324 A1
(43) Pub. Date: Dec. 5, 2013

(54) SYSTEM FOR REDUCING FINGER-COUPLED NOISE IN CAPACITIVE TOUCH SENSORS

(71) Applicants: Mykola Golovchenko, Cupertino, CA (US); Stanislav Pereverzev, Cupertino, CA (US); William Stacy, San Jose, CA (US)

(72) Inventors: Mykola Golovchenko, Cupertino, CA (US); Stanislav Pereverzev, Cupertino, CA (US); William Stacy, San Jose, CA (US)

(73) Assignee: TOUCH TURNS LLC, Santa Clara, CA (US)

(21) Appl. No.: 13/486,845

(22) Filed: Jun. 1, 2012

(51) Int. Cl. G06F 3/044

(52) U.S. Cl. 345/174

(57) ABSTRACT

The invention is a system for reducing finger-coupling capacitance of a touch-sensor panel such that finger-coupled noise signals do not overwhelm the sensing circuit and render the panel unable to detect the finger position.

This application incorporates US Patent and Trademark Office utility patent application Ser. No. 13/279,139 as to drawings and descriptions related to the variety of reduced-bond structures. The structures described and claimed in this application are based on the structures described in application Ser. No. 13/279,139 with the addition of the novel structure aspects described, herein, which support reduced finger-coupled noise.

### TECHNICAL FIELD

The present invention relates to a structure for connecting touch-panel sensor electrodes to related electronic control subsystems for use in devices featuring touch-screen control.

### BACKGROUND OF THE INVENTION

Many of today's electronic devices, portable devices in particular, feature touch-panel control where a user touches a particular area of a glass screen, or an icon displayed below such a screen, and a subsystem detects that touch and performs a related control function. Touch-panel equipped glass screens are an alternative, for example, to having push-button or keyboard type input devices. In addition to sensing the location of a finger touch, such touch-panel screen controls can also be used to sense motion of the finger touch from one point to another and can respond by, for example, moving the position of an image, drawing a line segment, or increasing or decreasing the magnification of an image. These touch-panels and their control functions are well known in the art.

There are a variety of technologies used in touch-panel equipped systems to determine the position relative to the screen of the finger touch. One of the more current and popular technologies uses a mutual-capacitance sensing approach. For mutual-capacitance sensing, using a variety of materials and methods, an array of transparent sensor electrodes are placed, coplanar, onto a transparent glass screen forming so-called transmitter and receiver electrodes in close proximity to one another. The mutual capacitance between such electrodes arises from the fringing fields between such electrodes and is dependent on the length of the proximate (i.e. shared) edges. A voltage is applied to the transmitter electrode and the detector integrates the current at the receiver which is proportional to the mutual capacitance between the transmitter and receiver electrodes. The transmitter and receiver electrodes must remain isolated from one another, that is, the impedance measured between any two electrodes must be very high. The presence of a finger touch will add capacitance to ground lowering the effective mutual capacitance, and indicate where in the spatial array of transmitter and receiver electrodes the lowered mutual capacitance has occurred. That will coincide with where the finger has touched the glass panel. This is prior art and well known to someone practiced in the art.

Ordinarily, a handheld device is subject to noise signals that are a small fraction of those used in the finger-position-detection scheme just described. That is, any such noise signals coupled from earth ground by the finger touch to the sensing circuit will ordinarily not disrupt the finger-position-detection function. However, in cases where the handheld device using touch-control is electrically connected to another device, such as a laptop computer, and where that laptop or other device uses an ungrounded AC adaptor, then noise signals associated with the adaptor floating with reference to earth ground can be some orders of magnitude larger than the finger-position-detection signals.

When touched by a person's finger or fingers, that noise is coupled to and injected into the finger-position-detection function. Because of the magnitude of these signals, they typically overwhelm the finger-position-detection circuitry and function causing the device to malfunction.

Therefore, a way of reducing that finger-coupled noise would improve the performance of a device subject to common-mode signals such as those described.

### BRIEF SUMMARY OF THE INVENTION

It is, therefore, an object of the present invention to reduce the finger-coupled noise in capacitive-touch sensor subsystems.

Today's touch-control devices employ single- or double-layer sensors. In the latter case (e.g. double-layer sensors), the transparent transmit electrodes are all applied to one surface and the transparent receive electrodes are all applied on a second surface and oriented perpendicular to the transmit electrodes creating a row-column or X-Y sensing matrix of juxtaposed electrodes with transmit and receive electrodes closely spaced relative to one another and therefore contributing to high finger coupling capacitance (FIG. 6). In such cases, finger-coupled noise that is high with respect to a position-detection signal is likely to disrupt the control function.

In a single-layer sensor panel, transparent transmit and receive electrodes are co-planar. Whereas the TX electrodes are continuous, the RX electrodes are small transparent electrode structures interspersed between the TX electrodes as shown in FIG. 7.

Typically, these RX electrodes are individually interconnected to conducting pads located in an opaque periphery of the glass. These pads are then interconnected to conducting traces to form, in effect, a similar X-Y matrix such as that shown in FIG. 6. As a result, a single-layer sensor implemented as such would have no greater immunity to finger-coupled noise compared with a dual-layer sensor.

However, there is an advantage inherent to the single layer sensor. Those interspersed RX electrodes need not be interconnected so as to create an X-Y matrix such as that of FIG. 6. Instead, for example, the RX electrodes near adjacent TX electrodes can be interconnected in a non-orderly fashion (e.g. one that does not create mutually perpendicular electrodes such as those in FIG. 6). As shown in FIG. 9, the top-most RX electrode of the left-hand TX electrode is interconnected to the third-from-the-top RX electrode of the adjacent TX electrode. As a result, the top-most RX electrodes of the left-hand TX electrode and the TX electrode to its right are not interconnected. In fact, as one moves down the left-hand TX electrode, each of its RX electrodes are connected to the RX electrode of the adjacent TX electrode such that they never form an electrode structure that is mutually perpendicular to the TX electrodes. As a result, no two horizontally adjacent RX electrodes are interconnected to each other or to a common trace electrode. There would of course be no benefit to connecting two RX electrodes associated with the same TX electrode. A finger touch that couples noise to two horizontally adjacent RX electrodes will therefore couple noise to two rather than one RX line, and the amount of coupled noise to each line will be reduced thereby.

By making use of the single-layer electrode structures as disclosed in application Ser. No. 13/279,139, and by using the reduced-pad invention described therein, one is able to interconnect the “row” electrodes to common pads in such a structure, as described and claimed herein, that finger capacitance would be reduced thereby.

### BRIEF DESCRIPTIONS OF THE DRAWINGS

FIG. 1 depicts a touch-control sensor system whereby the touch-screen sensor panel (101) exchanges signals with a touch controller (102) which is in turn interpreted as finger position and motion by a host processor (103).

FIG. 2 depicts a typical, prior art, touch sensor circuit. A driving voltage on the one sensor electrode (206) causes charge to pass through the electrode resistance (201) and the mutual capacitance (205) between it and the other sensor electrode (207). The second sensor electrodes resistivity (202) will have retarding effect on the sensor signal at 207. The capacitances, 203 and 204, represent the parasitic capacitance between the electrodes and the proximate ground structure.

FIG. 3 shows the circuit of FIG. 2 with earth ground to the circuit forming a parallel path with earth ground through the person touching the panel via capacitance C_{F}. A driving voltage at T (301) generates a current in the capacitance C_{M}, which is detected at R (303). The presence of a finger touch couples the receiver electrode (R) to ground through the finger capacitance C_{F.} Thus, less current would be detected at R compared to measurement taken when no figure touch occurred. The reduced signal at R indicates the finger has touched the cross point of the T (TX) and R (RX) electrode.

FIG. 4 shows a common-mode noise voltage (401) that exists between earth ground and the sensing circuit. This noise is coupled into the sensing circuit and is directly proportional to the magnitude of C_{F}. A lower C_{F} would couple less noise to the sensing circuit.

FIG. 5 shows noise transmitted electromagnetically to the person then coupled through the finger capacitance, C_{F}, into the sensing circuit. Here, again, the amount of coupled noise is proportional to C_{F}.

FIG. 6 shows a prior art double-layer sensor panel where the transparent TX electrodes are fabricated on the lower surface of the glass (601) and the RX electrodes are fabricated on the upper surface (602). The finger coupling capacitance is proportional to the overlap of the contact area and receiver electrodes represented by the dotted-line circle. Because of the continuous structure of both the “column” (TX) and “row” (RX) electrodes, there is no interconnect configuration that would reduce that finger coupling capacitance nor the amount of noise coupled thereby. Coupled noise would be proportional to the size of the finger and the number of RX electrodes touched thereby because these RX electrodes are continuous.

FIG. 7 depicts a single-layer sensor panel where transparent “column” electrodes are continuous whereas “row” electrodes are implemented as small, rectangular transparent conductive electrodes that are isolated relative to one another and to the column electrodes. Thus, these “row” electrodes can be configured in a variety of ways dependent upon how they are subsequently interconnected to one another and to touch control traces.

As shown in FIG. 8, it is prior art and typical to connect all the top RX electrodes together to a common trace, all the second-from-the-top RX electrodes are coupled together to a different common trace, and so on. As a result, one ends up with an X-Y matrix of electrodes that is electrically equivalent to FIG. 6. As such, it also will have the same vulnerability to finger-coupled noise.

FIG. 9, however, shows that by interconnecting the RX electrodes in a non-ordered fashion, that is, a fashion which does not produce an X-Y matrix such as that of FIG. 6, one can achieve an interconnection pattern such that no two horizontally adjacent RX electrodes are connected to a common electrode. Therefore, any noise coupled to two horizontally adjacent RX electrodes will be coupled to two RX lines rather than one and, as a result, the amount of noise coupled to either line is reduced.

FIG. 10 shows the interconnection pattern (803) achieved by the layout scheme of FIG. 9. Note that the top two adjacent RX electrodes are not interconnected and would not produce a continuous electrode perpendicular to the TX electrodes.

FIG. 11 shows a finger-touch area that is analogous to 603 of FIG. 6. The finger touch does couple noise to both of the top-most RX electrodes, as shown, but as these are not part of a continuous line, but are in fact connected to two different RX lines, the noise coupled thereby would be split among those two lines.

FIG. 12 shows another embodiment where the separation between electrically interconnected RX electrodes is three row positions rather than just the one row of separation shown in FIG. 9. So long as the interconnection scheme produces this non-orderly RX electrode interconnection, the amount of finger-coupled noise will be decreased. It is found that a separation of at least one row, that is, an RX electrode interconnected to an adjacent TX electrode's RX electrode that is two column rows away from it, one can achieve acceptably low levels of coupled noise.

### DETAILED DESCRIPTION OF THE INVENTION

The following description covers the structure of the invention used to reduce finger-coupled noise to earth ground when using mutual-capacitance-based, single-layer, touch-control sensors.

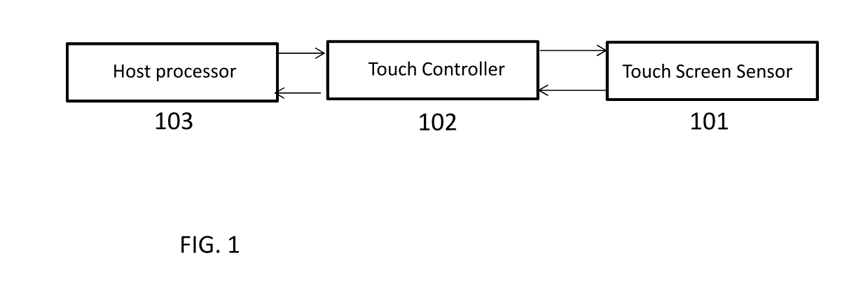

As shown in FIG. 1, touch-screen control systems comprise a sensor subsystem (101), a sensor control subsystem (102), and a host processor subsystem (103). Such touch-screen sensors can be implemented using opposite layers of a glass panel (e.g. a two-layer panel) and co-planar electrodes on a single layer of glass panel (e.g. a single-layer panel). This touch-sense control structure is well known in the art.

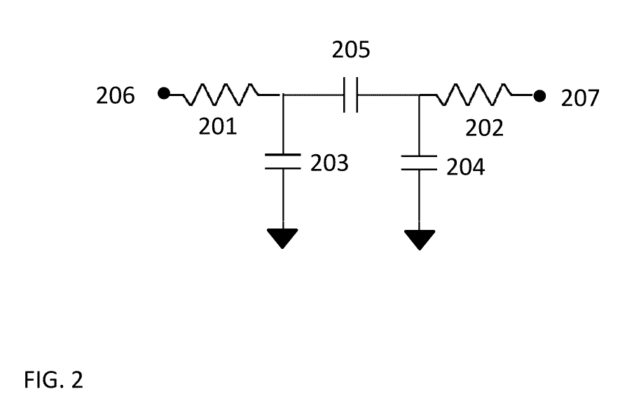

As shown in FIG. 2, a driving voltage on the one sensor electrode (206) causes charge to pass through the electrode resistance (201) and the mutual capacitance between it and the other sensor electrode (207). The second sensor electrodes resistivity (202) will have retarding effect on the sensor signal at 207. The capacitances, 203 and 204, represent the parasitic capacitance between the electrodes and the proximate ground structure. This circuit is well known in the art.

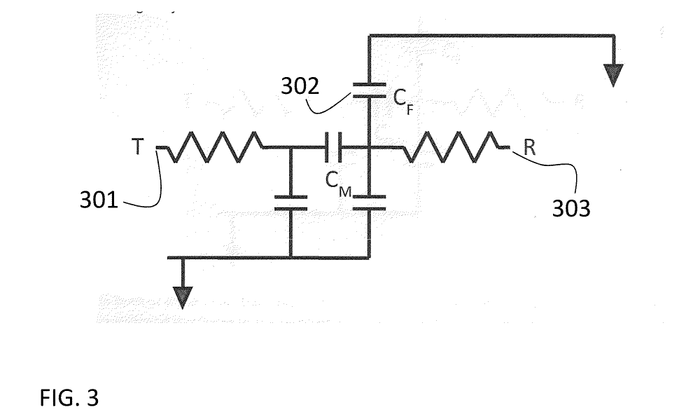

As shown in FIG. 3, a drive signal at T (301) produces a signal at R (303). A finger touch creates an additional capacitance (C_{F}) such that less signal is detected at R. The diminished signal is indicative that a finger has touched the cross point of a TX (T) and RX (R) electrode.

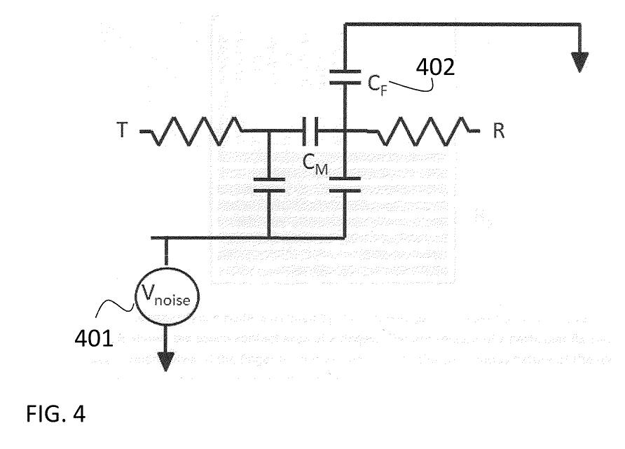

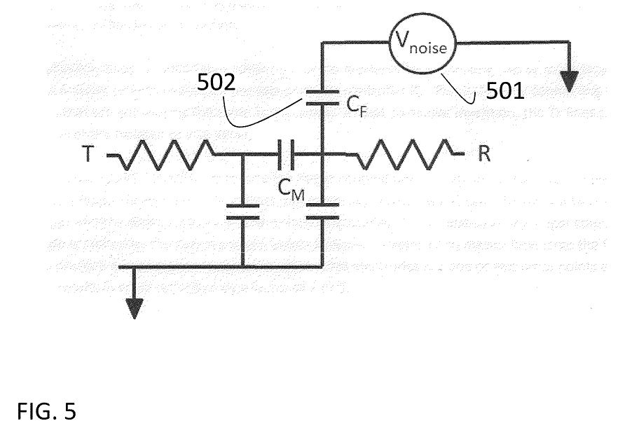

As shown in FIG. 4, a common-mode noise signal appearing in the path between the sensing circuit and earth ground will be injected into the sensing circuit in proportion to the value of C_{F}.

As shown in FIG. 5, a noise signal transmitted to a person and injected into the sensing circuit via a finger touch will also be proportional to the value of C_{F}.

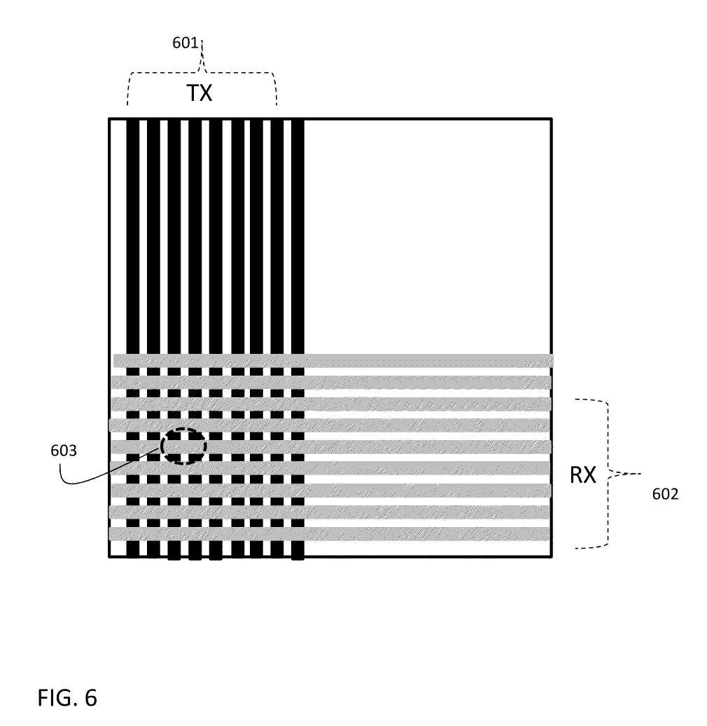

As shown in FIG. 6, a two-layer sensor panel typically has transparent TX electrodes (601) and RX electrodes (602) fabricated on opposite surfaces of the glass and oriented perpendicular to one another. Note that in this figure, the transparent TX electrodes would be considered column electrodes and the transparent RX electrodes would be considered row electrodes. Because of the continuous structure of both the column and row electrodes, the finger-coupling capacitance is dictated by the column and row electrodes' fixed positions relative to one another. Thus, the amount of noise coupled by a finger would be determined by the finger size.

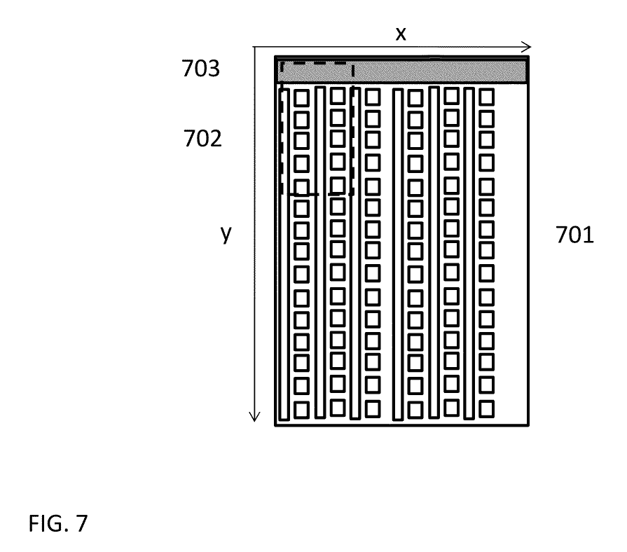

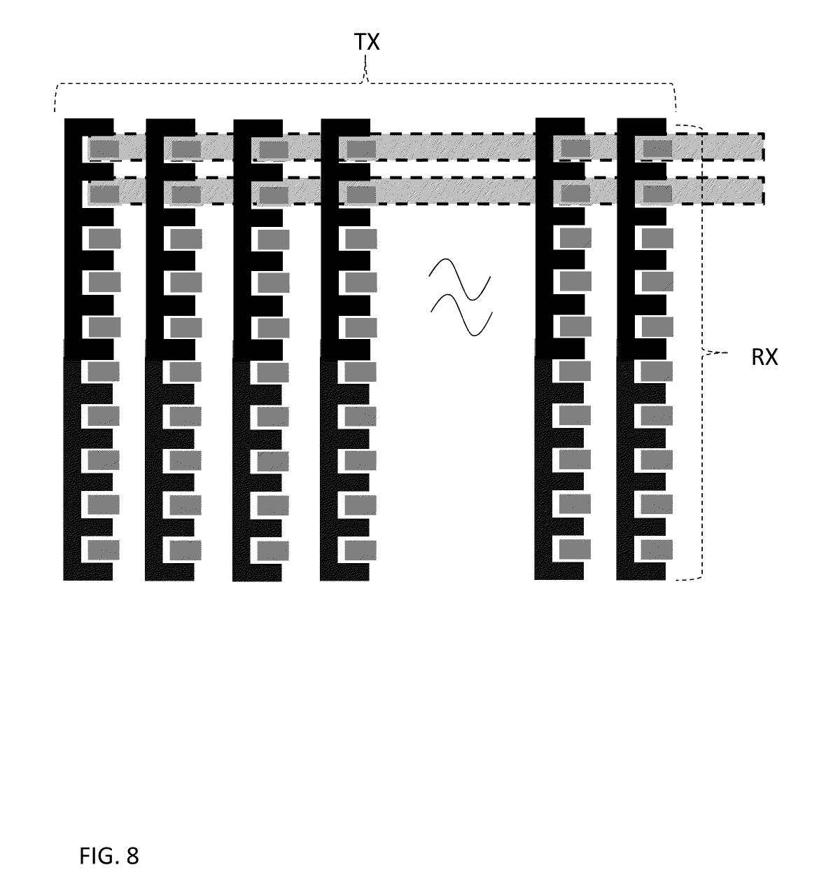

A single-layer sensor panel has continuous transparent column electrodes and small isolated transparent row electrodes, as shown in FIG. 7. Because the row electrodes are isolated from one another, they can be interconnected in ways where row electrodes associated with one column electrode are connected to row electrodes on an adjacent column electrode such that no two interconnected row electrodes are on the same row position. Neither would two RX electrodes associated with the same TX electrode be interconnected.

The primary advantage of a single-layer sensor is having all electrodes on one surface of the glass. As shown in FIG. 8, it is prior art to create an X-Y matrix of TX and RX electrodes such as that of a double-layer sensor (e.g. FIG. 6) by interconnecting the RX electrodes as shown in FIG. 8 so as to implement mutually perpendicular TX and RX electrodes. The methods for interconnecting RX electrodes on a single-layer sensor glass are well known in the art. By interconnecting the RX electrodes in that way, one ends up with the same vulnerability of finger-couple noise. That is, two horizontally adjacent RX electrodes are connected to a single RX line and as a result, all the noise is coupled to that single line.

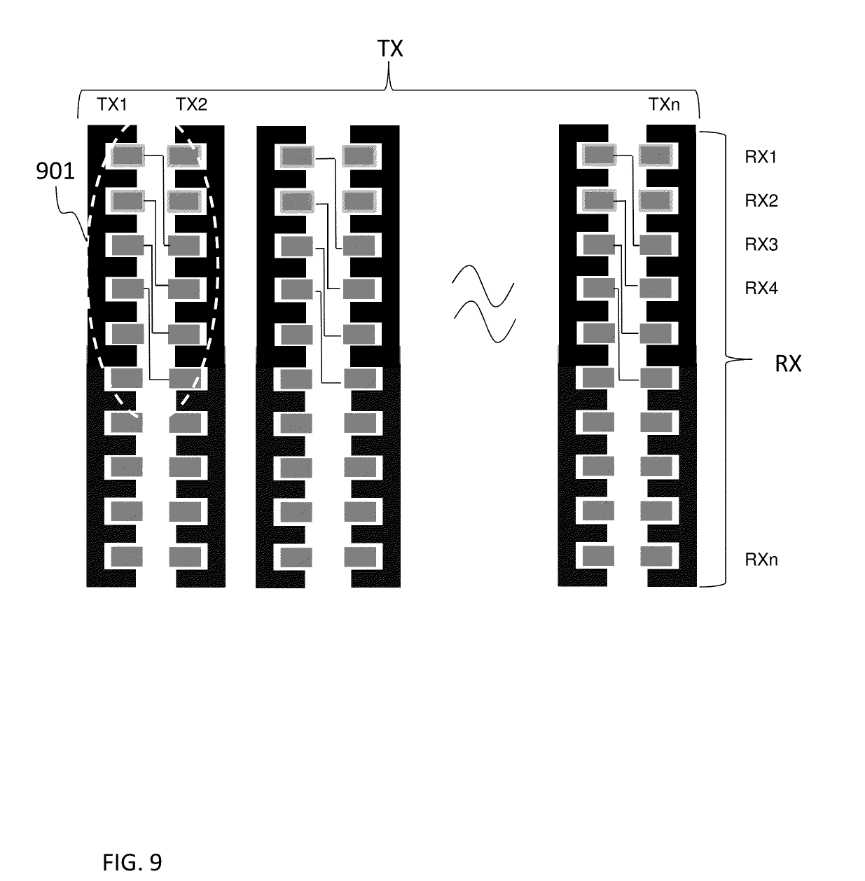

One advantage of a single-layer sensor is that the individual RX electrodes can be interconnected in a way that does not produce an orderly X-Y matrix of mutually perpendicular TX and RX electrodes. As shown in FIG. 9, in the area denoted by circle 901, the top-most RX (RX1) electrode of the left-hand TX electrode (TX1) is interconnected to the RX electrode on the adjacent TX electrode (RX3/TX2) that is three rows down. In an identical fashion, RX2/TX1 is interconnected to RX4/TX2), and so on. Thus, no two horizontally adjacent RX electrodes are interconnected to one another nor to a common RX line.

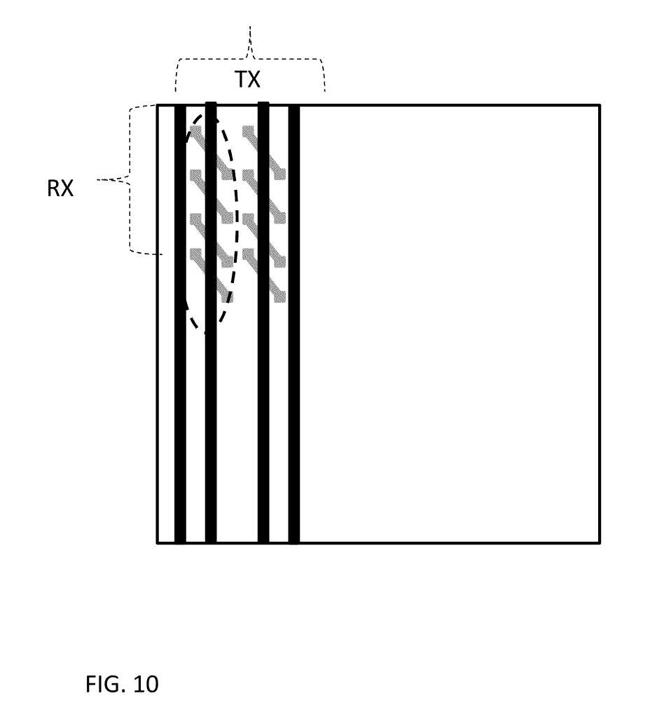

FIG. 10 shows the effect of the interconnection scheme depicted in FIG. 9. Instead of mutually perpendicular RX and TX electrodes as in FIG. 8 one ends up with pairs of interconnected RX electrodes that form a line segment that is not perpendicular to TX electrodes. Consequently, a finger touch that transfers noise to two horizontally adjacent RX electrodes will couple noise to two rather than one line and therefore couple a reduced amount of noise to each line.

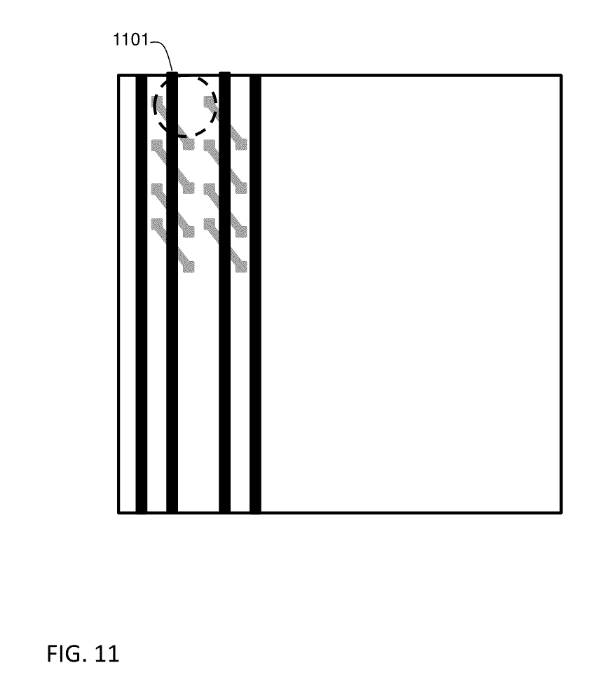

FIG. 11 shows a finger-touch area depicted by circular area 1101 which, as shown, could couple noise to the top-most adjacent RX electrodes. However, because these electrodes are not connected together nor to a common RX line, the signal coupled to each line would be effectively split.

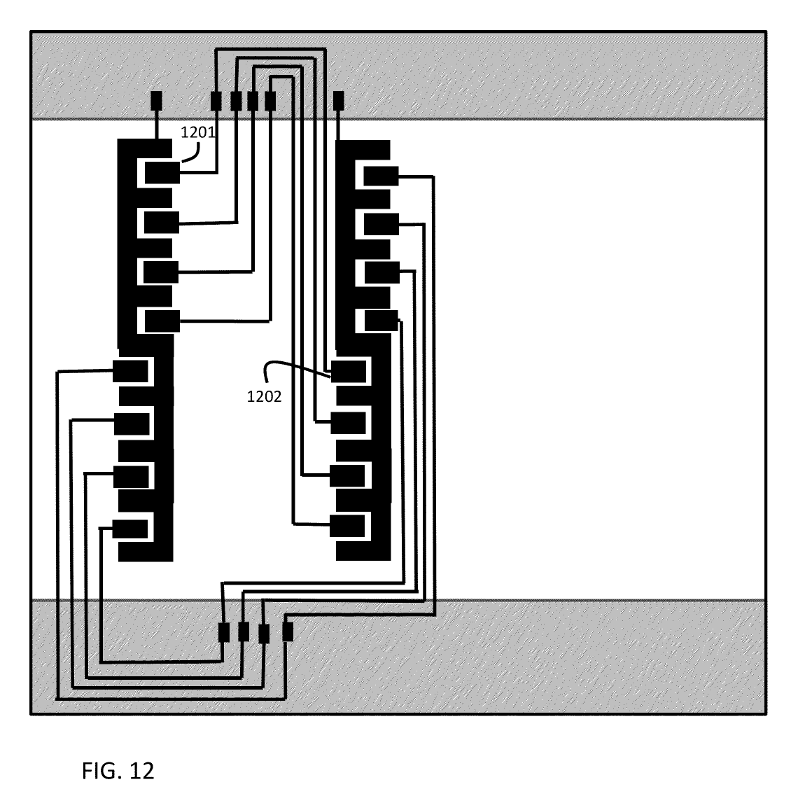

FIG. 12 shows an arrangement of TX and RX electrodes covered by the structures and methods of application Ser. No. 13/279,139. As shown, the top-most electrode of the left-hand TX electrode (1201) is connected to a pad in the upper-most opaque area of the glass. An RX electrode that is five rows down on the adjacent TX electrode (1202) is also connected to the same pad as 1201. Thus, these two electrodes are separated by four row positions but share a common pad. This result achieves the reduced finger-coupled noise result plus reduces the number of interconnect pads as described and claimed in application Ser. No. 13/279,139.

What is claimed is:

1. A system for reducing finger-coupling capacitance at a touch-control-panel touch point comprising:
A transparent non-conducting glass (i.e. sensor glass) with two parallel flat surfaces;
One or a plurality of transparent electrodes, herein referred to as TX column electrodes, extending continuously across one surface of said sensor glass;
One of a plurality of TX column electrodes arranged adjacent to one another, parallel to one another, and with intervening spaces between said TX column electrodes;
One or a plurality of transparent electrodes, herein referred to as RX row electrodes, sized and shaped such that said RX row electrodes may be located in the spaces between said TX column electrodes but electrically isolated from other said RX row electrodes and from said TX column electrodes and located on said one surface of said sensor glass;
One or a plurality of rows of said RX row electrodes comprising lines of said RX row electrodes extending perpendicular to one or a plurality of said TX column electrodes;
One of a plurality of transparent interconnect electrodes, herein referred to as interconnect electrodes;
Said interconnect electrodes interconnecting said RX row electrodes associated with any of said TX column electrodes to other of said RX row electrodes associated with an adjacent said TX column electrode such that one of each said RX row electrodes is interconnected to one of each said another RX row electrodes associated with an adjacent said TX electrode and which occupies a row different than that of each said RX row electrode to which it is interconnected.
